(19) United States
(12) Patent Application Publication
(10) Pub. No.: US 2010/0170228 A1
(43) Pub. Date: Jul. 8, 2010

(54) METHOD AND APPARATUS FOR TRUCK HEATED DUMP BODY

(75) Inventor: Hugh Thomas Dickinson, Greensboro, NC (US)

Correspondence Address: VOLVO TECHNOLOGY OF AMERICA, CORPORATE PATENTS, 7825 NATIONAL SERVICE ROAD, MAIL STOP, AP1/3-41, GREENSBORO, NC, 27409, US

(73) Assignee: VOLVO GROUP NORTH AMERICA, INC., Greensboro, NC (US)

(21) Appl. No.: 12/664,599

(22) PCT Filed: Dec. 18, 2007
(86) PCT No.: PCT/US07/25824

§ 371 Date: Dec. 14, 2009

(51) Int. Cl. F02D 45/00; F01N 3/023; F01N 5/02

(52) U.S. Cl. 60/287; 60/295; 60/320

(57) ABSTRACT

A control device for a truck dump body heating system includes a valve for controlling an exhaust gas flow to either an exhaust stack or an inlet to the dump body heating conduit. The valve may be manually controlled by the operator to select between the exhaust and heating functions. An override detects whether a diesel particulate filter regeneration is being performed, and responsive thereto, causes the valve to direct exhaust gas to the stack, preventing excessive heating of the dump body.

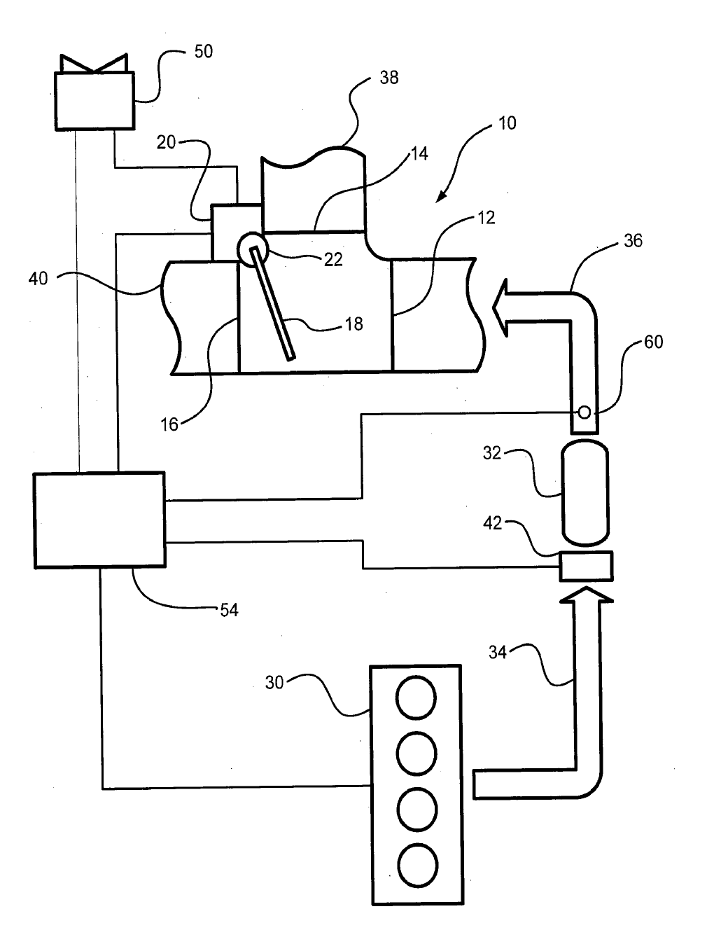

### FIELD OF THE INVENTION

The invention relates to dump trucks having conduits to convey exhaust gases to portions of the dump body for heating. More particularly, the invention relates to a control method and system for a dump body heating system.

### BACKGROUND AND SUMMARY OF THE INVENTION

Apparatuses for diverting a truck's exhaust gas to heat its dump body are known. Typically, an apparatus includes a valve for diverting exhaust gas from a stack pipe, through which the gas would escape to the environment, into a conduit path or circuit built into the dump body.

Dump body heating is useful, for example, in cold weather when the load in the dump body may freeze to the dump body or become solidified and difficult to unload. The art shows devices for controlling the exhaust gas diverter when the dump body is raised, and there is art showing spring controlled devices for controlling the diverter based on the position of the dump body.

U.S. Pat. No. 5,797,656 (Caterpillar) discloses an exhaust diverter apparatus as part of a dump body heater that uses an electronically operated valve for directing exhaust gas to either the dump body or the stack exhaust. The controller monitors the position of the dump body, so that exhaust is directed into the stack when the body is in raised position.

Recent changes in emissions regulations have resulted in the use of exhaust aftertreatment devices, such as diesel particulate filters to capture particulate matter in the exhaust flow. Diesel particulate filters require cleaning or removal of the collected particulate matter, which, otherwise over time can block the gas flow through the filter. An accepted manner of clearing the filter is a process called regeneration, involving raising the temperature of the exhaust stream entering the particulate filter sufficient high to cause the particulate matter, which is mostly carbon based, to burn. However, the high temperature of the exhaust gas during regeneration can cause damage to the dump body.

The patent art has not recognized the problem of excessive exhaust gas temperature (due to DPF regeneration or other causes) on the dump body. What is needed is a control for a dump body heating apparatus to prevent exhaust gas at high temperatures from reaching the dump body.

A control apparatus in accordance with the invention includes a controllable valve having a first position directing exhaust gas to an exhaust outlet pipe and a second position directing exhaust gas to an inlet to a dump body conduit, a switch functionally connected to the controllable valve for manually selecting between the first position and the second position, and, an override device being connected to receive a signal that an aftertreatment device regeneration is being performed and operationally connected to the controllable valve, the override device being configured to position the controllable valve in the first position responsive to receiving the signal.

The valve may be operated by an air cylinder using the vehicle's on-board compressed air supply, or may be a solenoid or other controllable valve.

The manual control switch may be conveniently located in the vehicle cab for operation by the driver.

According to the invention, the override device is in communication with the vehicle system that controls regeneration of the diesel particulate filter to receive a signal that regeneration is being performed. The override device is configured to cause the valve to a position for exhaust through the exhaust stack regardless of whether the driver has selected dump body heating. For times no regeneration is being performed, the driver or operator has control of the position of the valve.

The override device may also be configured to receive a signal indicative of a temperature of the exhaust gas exiting the diesel particulate filter, and causing the valve to move to the position for exhaust through the exhaust stack if the temperature is above a threshold determined to be harmful to the dump body.

### BRIEF DESCRIPTION OF THE DRAWINGS

The invention will be better understood by reference to the following detailed description in conjunction with the appended drawings, in which:

The sole FIGURE is a schematic diagram of a controlled dump body heating apparatus in accordance with the invention.

### DETAILED DESCRIPTION

A dump body heating control apparatus in accordance with the invention is shown in schematic view in the FIGURE. Particularly in colder weather, it is desirable to heat the body of a dump truck to facilitate releasing the load from the body. A load may become more solidified in colder weather, making it less able to flow, or may actually freeze to the dump body. Dump trucks may include a circuit formed in the dump body for the passage of exhaust gas therethrough for heating the dump body.

The apparatus is advantageously equipped on a vehicle having an engine 30 with an exhaust aftertreatment device, depicted here as a diesel particulate filter 32, connected to receive exhaust gas 34 from the engine 30 and capture and remove particulate matter from the exhaust. The treated exhaust 36 is delivered to either an exhaust stack 38 or a dump body heating circuit 40 by a controllable valve 10, as described in more detail below.

The diesel particulate filter 32 becomes clogged with collected particulate matter over time, and requires a clearing or regeneration process. Regeneration involves raising the exhaust gas temperature sufficiently high to cause the particulate matter in the diesel particulate filter to burn, and may be performed in a number of ways known in the art. For example, methods include changing engine operating characteristics, or, as illustrated, using a heating device 42 such as an electric heater, burner, or a hydrocarbon injector. A hydrocarbon injector injects hydrocarbon into the exhaust flow and a catalyst oxidizes the hydrocarbon resulting in a raise in temperature. The particular choice of method or device for raising exhaust gas temperature for regeneration is not a part of the invention, and a heating device 42 is shown by way of illustration.

Exhaust gas heated for diesel particulate filter regeneration may be sufficiently hot to damage the dump body. The invention provides a controllable apparatus that prevents excessively heated exhaust gas from entering the dump body heating circuit.

The apparatus includes a controllable valve 10 having an inlet 12 connectable to receive exhaust gas from an internal combustion engine 30, and having two outlets, a first outlet 14 connectable to an exhaust pipe 38 and a second outlet 16 connectable to an inlet 40 of a dump body heating circuit formed in a dump body, as is known in the art.

The controllable valve 10 includes a flow directing device, depicted here as a flap 18, that is selectably positionable against the first outlet 14 to guide exhaust flow through the second outlet 16 for entry into the dump body heating circuit for heating the dump body, or against the second outlet 16 to guide flow through the first outlet 14 for exhaust through the stack pipe 38 to the environment. The control valve 10 is shown as a flap valve, however, those skilled in the art will understand that other valves may be employed.

A motor 20 is operably connected to the flap 18 for moving the flap to the selected position. The motor 20 may be an air cylinder connected to receive compressed air from the vehicle's on-board compressed air system for actuation. Alternatively, the motor 20 may be a solenoid or other device capable of moving the flap 18 to the selected position. The flap 18 includes a biasing device 22 to bias the flap to the position closing the second outlet 16. The biasing device 22 acts to ensure that the default position of the flap 18 is to close the second outlet 16 and prevent exhaust from entering the dump body heating circuit 40.

A manually operated switch 50 is connected to the motor 20 for selecting the position of the flap 18. The switch 50 may be mounted in a place convenient for operator use, for example, on the dashboard or control panel of the vehicle. The switch 50 may be a rocker switch, pushbutton switch, or other switch having two positions corresponding to the two positions of the valve 10. The vehicle operator may select stack exhaust or dump body heating mode using the switch 40.

A control module 54 may be connected to the engine 30 to receive data from the engine and to control various engine functions. The control module 54 may also receive data regarding the particulate load status of the diesel particulate filter 32, and control the regeneration process. One known method for determining particulate load on the diesel particulate filter, for example, includes sensing a gas pressure drop across the diesel particulate filter. The control module 54 may be connected to the heating device (if provided) to initiate regeneration. Alternatively, on vehicles having systems that require an operator to initiate regeneration, the control module 54 will first receive an input from the operator before initiating the regeneration process.

To prevent the excessively hot gases produced during regeneration from entering the dump body heating circuit, the control module 54 is also connected to the motor 20 to send an override signal that positions the flap 18 in the position against the second outlet 16, despite the position of the selector switch 50. When the regeneration process is completed, the control module 54 will cancel the override, allowing the switch 50 to control the position of the flap 18.

Optionally, the apparatus may include a temperature sensor 60 to sense exhaust gas temperature on an outlet side of the diesel particulate filter 32. The temperature sensor 60 may advantageously be connected to deliver a signal indicative of the exhaust gas temperature to the control module 54. The control module 54 may use the temperature data as a further input for determining whether to apply the override on the motor 20. For example, at the end of the regeneration process it will take some time for the large heated mass of the diesel particulate filter to cool to a level at which exhaust gases will not damage the dump body. The control module 54 will delay canceling the override until the temperature of the exhaust gas has dropped to or below a threshold level.

In addition, there may be operating conditions of the engine, heavy load, for example, where the exhaust gas temperatures are sufficiently high themselves to damage the dump body or sufficiently high to support regeneration without assistance, such that the exhaust gas may damage the dump body. The control module 54 may monitor the temperature of the exhaust gas exiting the diesel particulate filter 32, and control the motor 20 responsive to exhaust gas temperature, imposing or canceling the override as appropriate.

The invention has been described in terms of preferred principles, embodiment, and components; however, those skilled in the art will understand that substitutions of equivalents may be made without departing from the scope of the invention as defined in the appended claims.

What is claimed is:

1. A control apparatus for heating a truck dump body, the dump body having at least one conduit for guiding exhaust gas through the dump body, the truck having an exhaust aftertreatment device requiring occasional regeneration, the control apparatus comprising:
a controllable valve having a first position directing exhaust gas to an exhaust outlet pipe and a second position directing exhaust gas to an inlet to a dump body conduit;
a switch functionally connected to the controllable valve for manually selecting between the first position and the second position; and,
an override device being connected to receive a signal that an aftertreatment device regeneration is being performed and operationally connected to the controllable valve, the override device being configured to cause the controllable valve to move to the first position responsive to receiving the signal despite the switch selection.

2. The control apparatus of claim 1, wherein the controllable valve includes a biasing device configured so that the first position is a default position.

3. The control apparatus of claim 1, wherein the controllable valve includes an air operated cylinder for moving the valve.

4. The control apparatus of claim 1, wherein the controllable valve includes a solenoid for moving the valve.

5. The control apparatus of claim 1, wherein the switch is disposed in a cab of the vehicle.

6. The control apparatus of claim 1, wherein the controllable valve comprises a body having an inlet and two outlets, a pivotable valve flap mounted for movement between alternative positions closing one of the two outlets.

7. The control apparatus of claim 1, further comprising a temperature sensor disposed to sense an exhaust gas temperature at an outlet of an exhaust gas aftertreatment device and connected to deliver a temperature signal to the override device, and wherein the override device is configured to position the controllable valve responsive to the delivered signal.

8. A method for controlling a dump body heating apparatus in a vehicle having an exhaust aftertreatment device requiring occasional regeneration, and having a controllable valve having a first position directing exhaust gas to an exhaust outlet pipe and a second position directing exhaust gas to an inlet to a dump body conduit, the method comprising the steps of:
monitoring whether regeneration of the aftertreatment device is in process;
responsive to regeneration being in process, controlling the controllable valve to the first position directing exhaust gas to the exhaust outlet pipe; and,
responsive to regeneration not being in process, allowing the controllable valve to be in a position selected by a vehicle operator.

9. The method of claim 8, further comprising the step of sensing an exhaust gas temperature at an outlet of the aftertreatment device, and responsive to the exhaust gas temperature being above a threshold level, controlling the controllable vale to the first position.
